(19) United States
(12) Patent Application Publication
(10) Pub. No.: US 2002/0171747 A1
(43) Pub. Date: Nov. 21, 2002

(54) Image capturing apparatus, and method of display-control thereof

(75) Inventors: Masahito Niikawa, Sakai-Shi (JP); Toshiyuki Tanaka, Nishinomiya-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 09/738,071

(22) Filed: Dec. 15, 2000

(30) Foreign Application Priority Data
Dec. 20, 1999 (JP) 11-361064

(51) Int. Cl. H04N 5/222

(52) U.S. Cl. 348/333.01; 348/333.02

(57) ABSTRACT

A digital camera includes a liquid crystal display (LCD) and an electronic viewfinder (EVF) both capable of displaying a captured image. The EVF displays a captured image, and the LCD produces a camera status display about settings in a recording mode. A user can use a crossed switch to change the setting of each selectable item in the camera status display. This allows the user to change the settings on the LCD while viewing the captured image on the EVF. Consequently, the plurality of monitors capable of displaying images are put to effective use.

This application is based on application No. 11-361064 filed in Japan, the contents of which are hereby incorporated by reference.

### BACKGROUND OF THE INVENTION

1. Field of the Invention

The present invention relates to an image capturing apparatus and, more particularly, to an image capturing apparatus which displays images on a plurality of monitors, for example, an electronic viewfinder and a liquid crystal display.

2. Description of the Background Art

Some image capturing apparatuses, such as digital cameras, have been put to practical use each of which comprises a plurality of monitors, for example, an electronic viewfinder and a liquid crystal display for displaying captured images and playback images.

Unfortunately, these electronic cameras are used in such a manner that the same captured image is displayed on all of the monitors or that a captured image and recording-mode settings are displayed on only one of the monitors. The two monitors are not necessarily put to effective use.

In response to requests for multiple functions, an electronic camera has a great number of selectable recording-mode items which a user can change. It is desirable that the user can view what changes are to be made in the captured image according to changes in recording-mode settings. However, if a multiplicity of selectable recording-mode items are displayed on an electronic camera monitor having a limited size, a monitor screen is filled with only the selectable recording-mode items by themselves, and has no space left for displaying an image resulting from the changes in recording-mode settings. Thus, it is difficult to display both the captured image and information different from the captured image on the single monitor.

### SUMMARY OF THE INVENTION

The present invention is intended for an image capturing apparatus.

According to the present invention, the image capturing apparatus comprises: a first display capable of electrically displaying a captured image; a second display capable of electrically displaying a captured image; and a controller for simultaneously causing the first display to display the captured image and the second display to display information different from the captured image. Therefore, the plurality of monitors capable of displaying images are put to effective use.

In the image capturing apparatus according to one aspect of the present invention, the information includes information about a setting in a shooting mode. This allows a user to easily associate the captured image and the setting in the shooting mode with each other.

Additionally, in the image capturing apparatus according to the present invention, the information includes a correctable item associated with image correction, and information about a setting of the correctable item. This allows the user to easily contrast the setting and the image subjected to the image correction with each other

The present invention is also intended for a method of display control in an image capturing apparatus including a first display and a second display both capable of electrically displaying a captured image.

It is therefore an object of the present invention to provide an image capturing apparatus which can effectively use a plurality of monitors thereof capable of displaying an image.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a digital camera according to one preferred embodiment of the present invention;

FIG. 2 is a cross-sectional view taken along the line II-II of FIG. 1;

FIG. 3 is a rear view of the digital camera of FIG. 1;

FIG. 4 is a functional block diagram of the digital camera of FIG. 1;

FIG. 5 is a block diagram showing an internal construction of an overall controller;

FIG. 6 illustrates image storage in a memory card;

FIG. 7 is a flowchart illustrating the overview of the operation of a photographing process;

FIG. 8 illustrates the display of additional information;

FIG. 9 is a flowchart illustrating the overview of the operation of display mode selection;

FIG. 10 is a flowchart illustrating the overview of the operation in a setting mode;

FIG. 11 illustrates the operation of selecting and inputting a camera status;

FIG. 12 shows the details of a camera status display on an LCD;

FIGS. 13A, 13B, 14A, 14B, 15A and 15B show camera status selection screens; and

FIGS. 16A and 16B illustrate the operation of selecting and inputting image correction.

### DESCRIPTION OF THE PREFERRED EMBODIMENTS

<Construction of Principal Parts of Digital Camera in Preferred Embodiment>

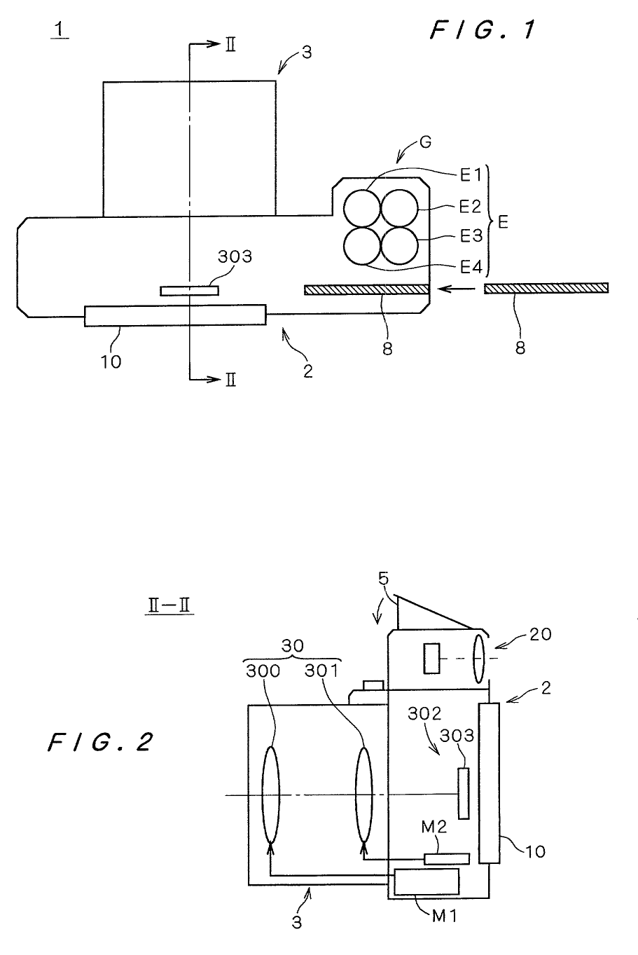

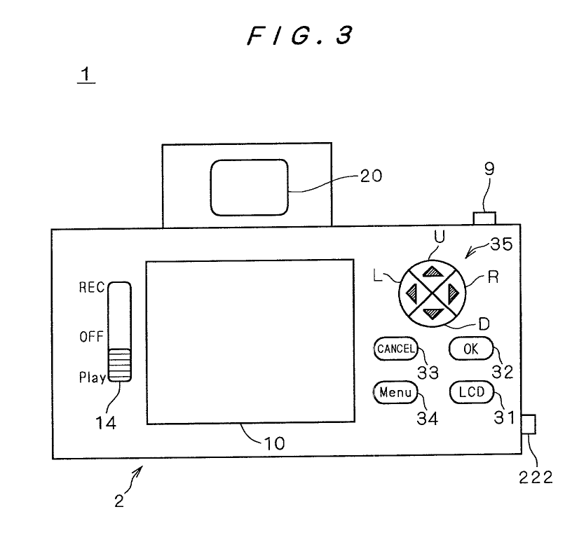

FIGS. 1 through 3 show the construction of principal parts of a digital camera 1 according to one preferred embodiment of the present invention. FIG. 1 is a plan view, FIG. 2 is a cross-sectional view taken along the line II-II of FIG. 1, and FIG. 3 is a rear view. These figures are not necessarily drawn based on the third angle projection, but are intended to conceptually illustrate the construction of the principal parts of the digital camera 1.

As shown in FIGS. 1 through 3, the digital camera 1 is divided generally into a camera body 2 having the shape of a substantially rectangular parallelepiped, and an image capturing section 3.

The image capturing section 3 includes an image capturing circuit 302 having a CCD color area sensor 303 and provided in position behind a lens group 30 with macro capability serving as taking lenses. The lens group 30 includes a zoom lens 300 and a focusing lens 301.

In the camera body 2 are provided a zoom motor M1 for changing the zoom ratio of the zoom lens 300 and for moving the zoom lens 300 between a retracted position and an image capturing position, and a motor M2 for driving the focusing lens 301 to achieve focus.

The front surface of the camera body 2 is provided with a grip G. A pop-up built-in flash 5 is provided in position in an upper end part of the camera body 2. A shutter release button 9 is provided on the upper surface of the camera body 2.

With reference to FIG. 3, the rear surface of the camera body 2 has a liquid crystal display (LCD) 10 in its generally midportion and an electronic viewfinder (EVF) 20 both for displaying the live view of an image being captured, the playback of a recorded image and the like. The LCD 10 and the EVF 20 display images in color.

A recording/playback mode selection switch 14 for selection between a “recording mode” (“REC”) and a “playback mode” (“Play”) is provided on the rear surface of the camera body 2. The recording mode is the mode of taking pictures, and the playback mode is the mode of playing back and displaying on the LCD 10 captured images recorded on a memory card 8.

A crossed switch 35 with buttons U, D, L and R is provided in a right-hand position on the rear surface of the digital camera 1. Pressing the buttons L and R drives the zoom motor M1 to zoom in and out. The buttons U, D, L and R are used for various operations to be described later.

An LCD button 31, an OK button 32, a cancel button 33 and a menu button 34 are provided on the rear surface of the camera body 2. The LCD button 31 functions as a selector for turning on and off the LCD display or the EVF display. The LCD display or the EVF display is switched on and off each time the LCD button 31 is pressed (as will be described in detail later).

An external monitor terminal 222 is provided on a side surface of the camera body 2. The external monitor terminal 222 is a terminal for transmitting image data and the like from the digital camera 1 to an external monitor.

As illustrated in FIG. 1, the digital camera 1 is designed to receive the memory card 8. The digital camera 1 is driven by a power battery E having four in-series connected AA cells E1 to E4.

<Functional Blocks of Digital Camera 1>

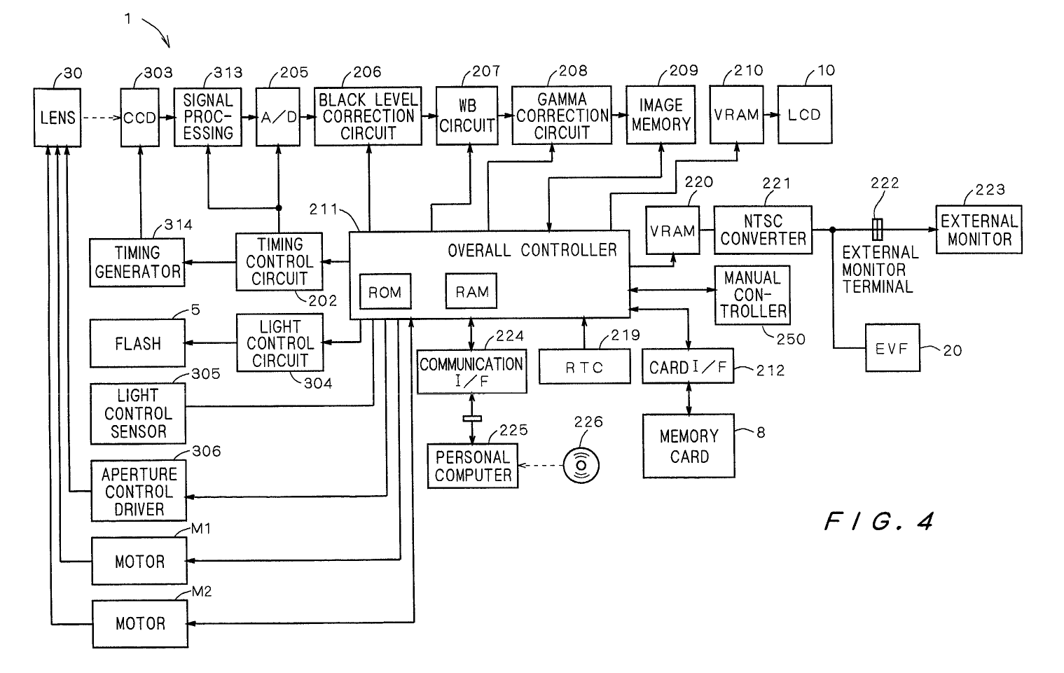

FIG. 4 is a functional block diagram of the digital camera 1. Referring to FIG. 4, a CCD 303 converts an optical image of a subject which is image-formed by the lens group 30 into an electrical image signal (comprised of a sequence of pixel signals from respective pixels which have detected light) having R (red), G (green) and B (blue) color components to output the image signal. A timing generator 314 generates various timing pulses for controlling the drive of the CCD 303.

Exposure control in the image capturing section 3 is performed by adjusting the aperture of the lens group 30 by an aperture control driver 306 and the amount of light exposure in the CCD 303, i.e., the charge storage time in the CCD 303 corresponding to a shutter speed. If a proper shutter speed is not set at a low subject brightness, incorrect exposure because of underexposure is corrected by level adjustment of the image signal outputted from the CCD 303. That is, at the low brightness, the exposure control is performed by using the shutter speed and gain adjustment in combination. The level adjustment of the image signal is made by the gain control of an AGC circuit in a signal processing circuit 313.

The timing generator 314 generates a drive control signal for the CCD 303, based on a reference clock transmitted from a timing control circuit 202. The timing generator 314 generates clock signals such as an integration start/end (exposure start/end) timing signal and read control signals (a horizontal sync signal, a vertical sync signal, a transfer signal, and the like) for light detection signals of respective pixels, to output the clock signals to the CCD 303.

The signal processing circuit 313 performs predetermined analog signal processing upon the image signal (analog signal) outputted from the CCD 303. The signal processing circuit 313 comprises a CDS (correlated double sampling) circuit and an AGC (automatic gain control) circuit. The signal processing circuit 313 reduces noises in the image signal in the CDS circuit, and adjusts the gain in the AGC circuit to adjust the level of the image signal.

A light control circuit 304 controls the amount of light to be emitted from the built-in flash 5 for flash photography to a predetermined amount established by an overall controller 211. In the flash photography, a light control sensor 305 detects the flash light reflected from the subject at the same time as the start of exposure, and the light control circuit 304 outputs a light emission stop signal when the amount of flash light detected by the light control sensor 305 reaches the predetermined amount. In response to the light emission stop signal, the built-in flash 5 is forced to stop emitting light. This allows the control of the amount of light emitted from the built-in flash 5 to the predetermined amount.

An A/D converter 205 converts each of the pixel signals included in the image signal into a 12-bit digital signal. The A/D converter 205 converts each of the pixel signals (analog signals) into the 12-bit digital signal, based on a clock for A/D conversion inputted from the timing control circuit 202.

The timing control circuit 202 for generating the clocks for the timing generator 314 and the A/D converter 205 is controlled by a reference clock in the overall controller 211.

A black level correction circuit 206 corrects the black level of the A/D converted pixel signals to a reference black level. A WB (white balance) circuit 207 converts the level of pixel data about the R, G and B color components. The WB circuit 207 uses a level conversion table inputted from the overall controller 211 to convert the level of the pixel data about the R, G and B color components. A parameter (the gradient of a characteristic curve) for each color component in the level conversion table is automatically or manually established for each captured image by the overall controller 211.

A gamma correction circuit 208 corrects the brightness of the pixel data. An image memory 209 is a memory for storing therein the pixel data outputted from the gamma correction circuit 208. The image memory 209 is capable of storing pixel data about one frame. In other words, the image memory 209 has a pixel data storage capacity of 1600×1200 pixels corresponding to the number of pixels in the CCD 303, and stores these pixel data in corresponding pixel locations.

An LCD VRAM 210 is a buffer memory for image data to be displayed on the LCD 10. The LCD VRAM 210 has an image data storage capacity of 400×300 pixels corresponding to the number of pixels in the LCD 10.

An EVF VRAM 220 is a buffer memory for image data to be displayed on the EVF 20. The EVF VRAM 220 has an image data storage capacity of 640×480 pixels corresponding to the number of pixels in the EVF 20.

In a shooting standby state, a plurality of pixel data about an image captured every 1/30 second by the image capturing section 3 are subjected to predetermined signal processing in the A/D converter 205, the black level correction circuit 206, the WB circuit 207 and the gamma correction circuit 208. Thereafter, the processed pixel data are temporarily stored in the image memory 209, and also transferred through the overall controller 211 to the LCD VRAM 210 and the EVF VRAM 220 for image display on the LCD 10 and the EVF 20 (live view display).

This allows a user to view a subject image. In the playback mode, an image read from the memory card 8 is subjected to predetermined signal processing in the overall controller 211, and then transferred to the VRAM 210 for image playback and display on the LCD 10. Similar image display is performed on the EVF 20.

A card I/F 212 is an interface for writing and reading image data therethrough into and from the memory card 8. A communication I/F 224 is an interface, e.g. a USB-compliant interface, for external connection to a personal computer 225 for communication. Via the card I/F 212 and the communication I/F 224, a ROM in the overall controller 211 can receive a control program recorded on a recording medium such as the memory card 8 and a CD-ROM 226.

An RTC 219 is a clock circuit for managing the date and time of photographing, and is driven by another power source not shown.

A manual controller 250 comprises various switches and buttons such as the shutter release button 9, the LCD button 31, and the OK button 32 described above.

The shutter release button 9 is a two-position switch capable of detecting a half-pressed position (S1) and a full-pressed position (S2) as used in conventional cameras with silver halide films. When the shutter release button 9 is pressed into the half-pressed position (S1) in a standby state, the lens group 30 starts being driven for auto-focus. Then, while the overall controller 211 evaluates the contrast of the image in the image memory 209, the motors M1 and M2 drive and stop the lens group 30 to achieve a higher contrast. A shutter speed (SS) and an aperture value are determined by judging the level of the image data in the image memory 209 when the shutter release button 9 is in the half-pressed position (S1). Further, the correction value of white balance is determined.

An NTSC converter 221 converts an image signal stored in the VRAM 220 into an NTSC signal to transfer the NTSC signal to the EVF 20 and through the external monitor terminal 222 to an external monitor 223.

The overall controller 211, in the form of a microcomputer, controls the drive of the above-mentioned components of the digital camera 1 to exercise centralized control over the shooting operation of the digital camera 1.

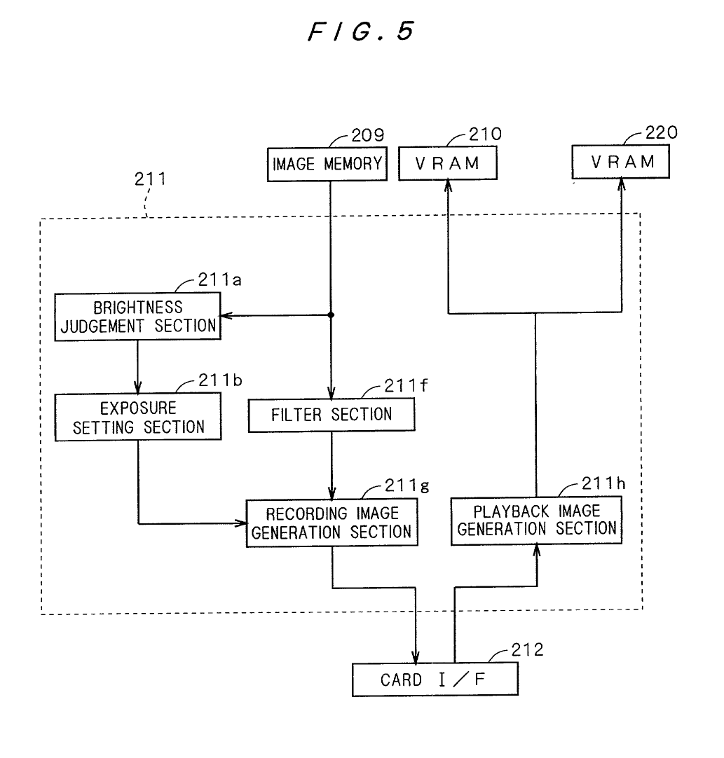

FIG. 5 is a block diagram showing the internal functions of the overall controller 211 which are implemented by a CPU and memories in the overall controller 211. The overall controller 211 shown in FIG. 5 comprises a brightness judgement section 211a and an exposure setting section 211b both for setting exposure control values (the shutter speed (SS) and the aperture value).

To record the above-mentioned captured image, the overall controller 211 further comprises a filter section 211f for performing a filtering process, and a recording image generation section 211g for generating a thumbnail image and a compressed image. To play back on the LCD 10 and the EVF 20 the image recorded on the memory card 8, the overall controller 211 further comprises a playback image generation section 211h for generating a playback image.

The filter section 211f uses a digital filter to correct a high-frequency component of the image to be recorded, thereby correcting the image quality about outlines.

The recording image generation section 211g reads pixel data from the image memory 209 to generate the thumbnail image and the compressed image which are to be recorded on the memory card 8. The recording image generation section 211g reads the pixel data regarding every eighth pixel in both the transverse and longitudinal directions from the image memory 209 to sequentially transfer the read pixel data to the memory card 8, thereby generating and recording the thumbnail image on the memory card 8.

Further, the recording image generation section 211g reads all of the pixel data from the image memory 209 to perform predetermined JPEG compression such as two-dimensional discrete cosine transform (DCT) or Huffman coding upon the pixel data to generate compressed image data, and then records the compressed image data in a corresponding image area of the memory card 8.

In the recording mode, after image capturing is indicated by the shutter release button 9, the overall controller 211 generates the thumbnail image and the JPEG compressed image at an established compression rate from the image captured by the image memory 209, and stores in the memory card 8 the thumbnail and compressed images with information such as tag information about the captured image (e.g., frame number, exposure value, shutter speed, compression rate, the date and time of photographing, flash on/off data at photo taking, scene information, and the result of judgment about the image).

Each frame of the image recorded by the digital camera 1 includes tag information, JPEG-compressed high-resolution image data (1600×1200 pixels), and image data (80×60 pixels) for thumbnail display.

When the recording/playback mode selection switch 14 is in the “playback mode” position, image data of the highest frame number in the memory card 8 is read out, and is decompressed by the playback image generation section 211h. The decompressed data is transferred to the VRAMs 210 and 220. Thus, the image of the highest frame number or the latest captured image is displayed on the LCD 10 and the EVF 20. Pressing the button U displays the image of a higher frame number, and pressing the button D displays the image of a lower frame number.

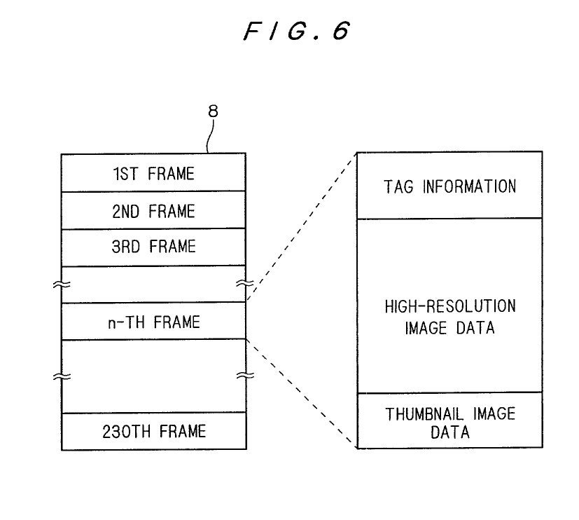

As shown in FIG. 6, the memory card 8 is capable of storing therein 230 frames of images stored by the digital camera 1 at a compression rate of 1/20. Each of the frames includes tag information, a JPEG-compressed high-resolution image signal (640×480 pixels), and an image signal (80×60 pixels) for thumbnail display. Each of the frames may be handled as, for example, an EXIF-format image file.

<Operation of Digital Camera 1>

Description will be given on the operations of the digital camera 1 about a photographing process and about the selection among four display modes on the LCD 10 and the EVF 20. Operations other than the photographing process and the display mode selection are conventional operations of digital cameras.

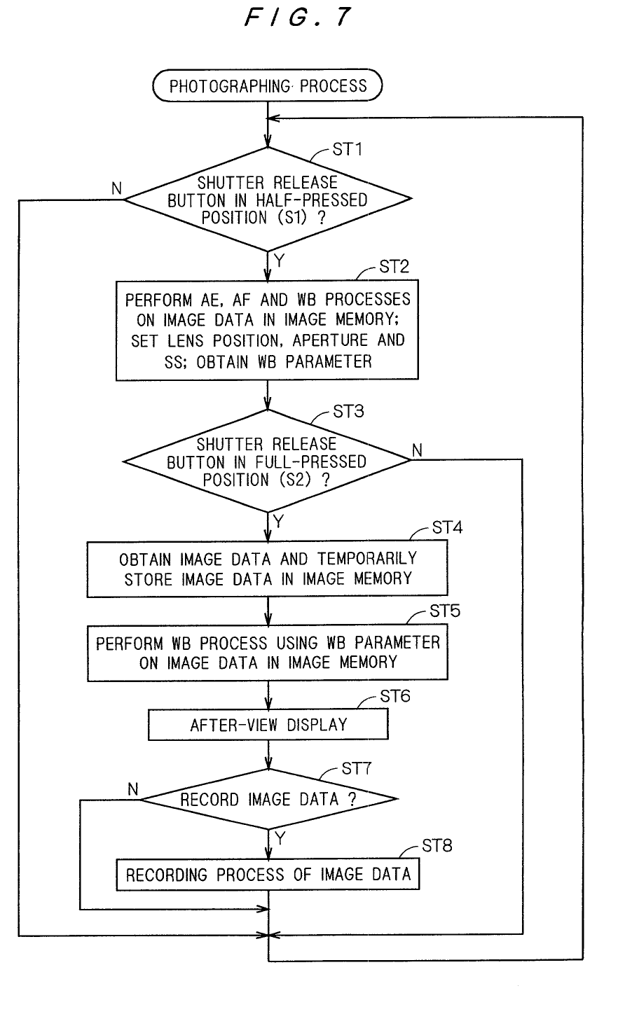

FIG. 7 is a flowchart illustrating the outline of the operation of the photographing process.

First, whether or not the shutter release button 9 is in the half-pressed position (S1) is judged in Step ST1. If the shutter release button 9 is in the half-pressed position, the flow proceeds to Step ST2.

Various processing and setting of the digital camera 1 are performed in Step ST2. More specifically, the overall controller 211 performs AE, AF and WB processes upon the image data in the image memory 209. Further, the overall controller 211 sets the position of the lens group 30, the aperture and the shutter speed (SS) for photographing, and obtains a WB parameter.

Whether or not the shutter release button 9 is in the full-pressed position (S2) is judged in Step ST3. If the shutter release button 9 is in the full-pressed position, the flow proceeds to Step ST4. If the shutter release button 9 is not in the full-pressed position, the flow returns to Step ST1.

In Step ST4, the CCD 303 obtains the image data, which in turn is temporarily stored in the image memory 209.

In Step ST5, the WB process using the WB parameter obtained in Step ST2 is performed on the image data stored in the image memory 209.

In Step ST6, an after-view display, i.e. the display of a captured image immediately after shooting is produced. The after-view display is selected among the display of the captured image, the display of additional information about the captured image, and non-display, depending on the settings (see Table 2) of the digital camera 1.

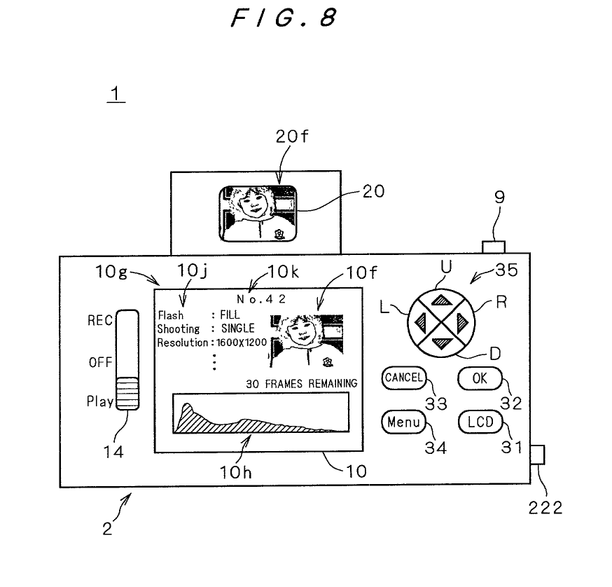

FIG. 8 illustrates the display of the additional information about the captured image.

In the digital camera 1, a captured image 20f is displayed on the EVF 20, and a captured image 10f is also displayed on the LCD 10. An additional information display 10g regarding shooting conditions recorded at the time of shooting is also produced on the LCD 10. The captured image 10f and the additional information display 10g serve as second information. The additional information display 10g includes a camera status setting display 10j, a shot frame number display 10k, and a histogram 10h.

The histogram 10h shows a brightness value on the horizontal axis versus the number of pixels on the vertical axis. A user checks the histogram 10h to easily judge whether or not exposure is proper for the captured image.

The display of the additional information about the captured image as above described allows the user to contrast the captured image and the additional information about the captured image with each other, to enhance convenience.

Reference will be made again to the flowchart of FIG. 7 for the following description.

Whether or not to record the captured image data on the memory card 8 is judged in Step ST7. To record the image data, the user presses the OK button 32, and the flow proceeds to Step ST8; otherwise, the user presses the cancel button 33, and the flow returns to Step ST1.

A recording process is performed on the image data in Step ST8. In this preferred embodiment, the captured image data is stored in the memory card 8.

Next, the display mode selection operation on the LCD 10 and the EVF 20 will be discussed.

The digital camera 1 has the four display modes (LCD&EVF_Status) as shown in Table 1.

TABLE 1

| Display Mode | | |
|---|---|---|
| (LCD & EVF_Status) | EVF | LCD |
| 0 | Off | Live View Display |
| 1 | Live View Display | Off |
| 2 | Live View Display | Live View Display |
| 3 | Live View Display | Camera Status Display |

In the display mode “0,” display is off on the EVF 20, whereas the LCD 10 produces live view display, or displays a live view image being currently captured by the CCD prior to actual image shooting.

In the display mode “1” which is the reverse of the display mode “0,” live view display is produced on the EVF 20, whereas display is off on the LCD 10.

In the display mode “2,” live view display is produced on both the EVF 20 and the LCD 10.

In the display mode “3,” live view display is produced on the EVF 20, whereas camera status display (to be described later) indicating settings of the digital camera 1 as shown in FIG. 12 is produced on the LCD 10.

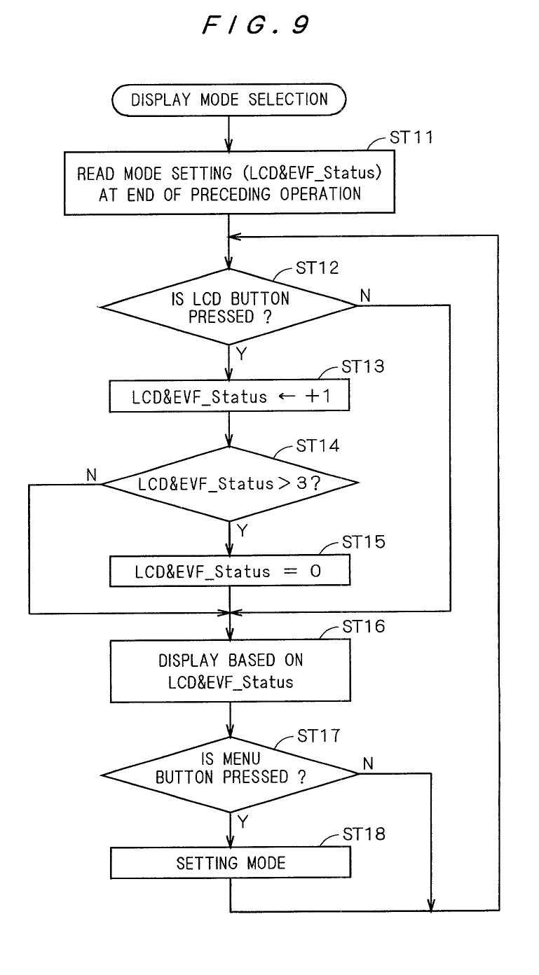

FIG. 9 is a flowchart illustrating the outline of the display mode selection operation.

A display mode setting (LCD&EVF_Status) which has been selected at the end of the preceding operation or at turn-off of the digital camera 1 is read in Step ST11. It should be noted that Step ST11 is performed only when power is turned on.

In Step ST12, whether or not the LCD button 31 serving as a display mode selection switch is pressed is judged. If the LCD button 31 is pressed, the flow proceeds to Step ST13. If the LCD button 31 is not pressed, the flow proceeds to Step ST16.

In Step ST13, LCD&EVF_Status is incremented by one. That is, the following operation is performed: LCD&EVF_Status=LCD&EVF_Status+1.

In Step ST14, whether or not LCD&EVF_Status is greater than three is judged. If LCD&EVF_Status is greater than three, the flow proceeds to Step ST15. If LCD&EVF_Status is not greater than three, the flow proceeds to Step ST16.

In Step ST15, zero is substituted for LCD&EVF_Status. This process step limits LCD&EVF_Status to three or less since the mode setting ranges from zero to three, as described above.

In Step ST16, the captured image or the like is displayed on the LCD 10 and the EVF 20, based on the display mode (LCD&EVF_Status).

The above-mentioned process steps allow the selection among the four display modes on the LCD 10 and the EVF 20.

In Step ST17, whether or not the menu button 34 is pressed is judged. If the menu button 34 is pressed, the flow proceeds to Step ST18. If the menu button 34 is not pressed, the flow returns to Step ST12.

In Step ST18, the current screen is changed to a setting mode.

FIG. 10 is a flowchart illustrating the outline of the operation in the above-mentioned setting mode.

In Step ST21, a judgement is made as to whether or not the display mode (LCD&EVF_Status) is “3,” i.e., whether or not the camera status display is produced on the LCD 10. If the display mode is “3,” the flow proceeds to Step ST22. If the display mode is not “3,” the flow proceeds to Step ST26.

In Step ST22, a camera status setting associated with the settings in the recording mode is inputted.

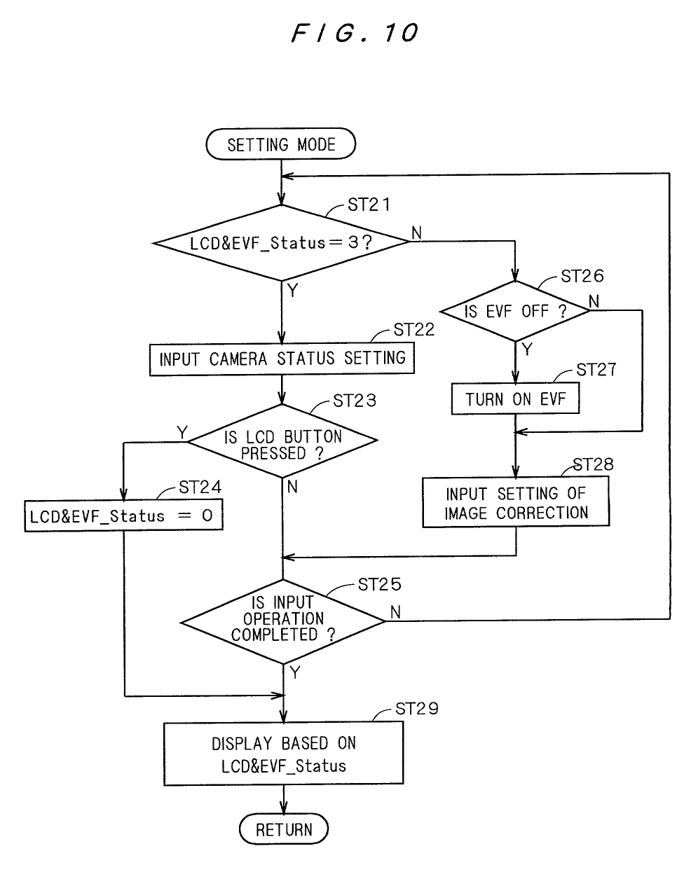

FIG. 11 is a view corresponding to the rear view of the digital camera 1 shown in FIG. 3 and illustrates the operation of inputting the camera status setting.

In the digital camera 1, a captured image 20s is displayed on the EVF 20, and a camera status display 10s is produced on the LCD 10.

FIG. 12 shows the details of the camera status display 10s produced on the LCD 10. As illustrated in FIG. 12, the camera status display 10s includes selectable items such as “flash,” “shooting,” and “image quality” with their settings.

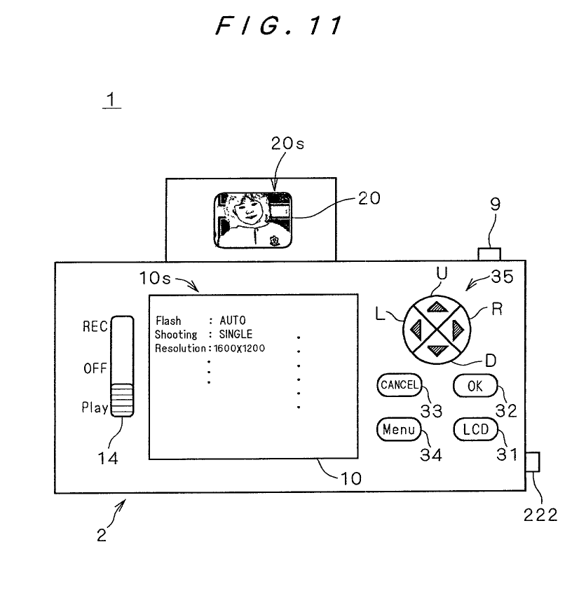

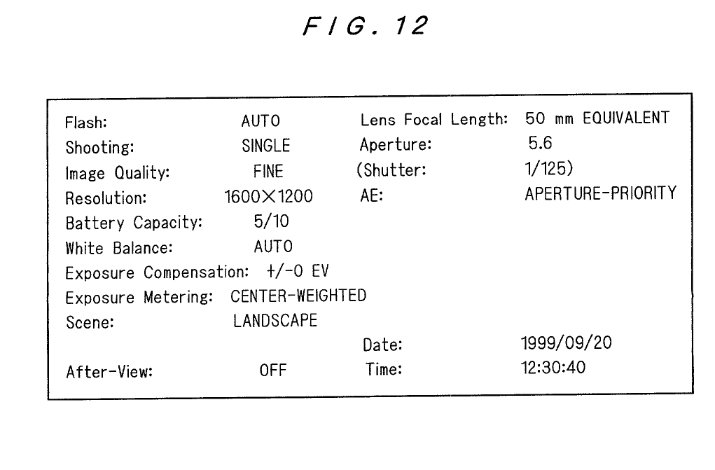

In this state, pressing the menu button 34 causes an underline L1 to appear as shown in FIG. 13A. The item underneath which the underline L1 is drawn, “flash” in this case, is selected.

Pressing the button D once moves the underline L1 downwardly one line to change the selected item to the “shooting,” placing the “shooting” setting in the user-selectable state, as shown in FIG. 13B. On the other hand, the user may press the button U to move the underline L1 upwardly one line. In this manner, the user can press the buttons U and D to select a desired item.

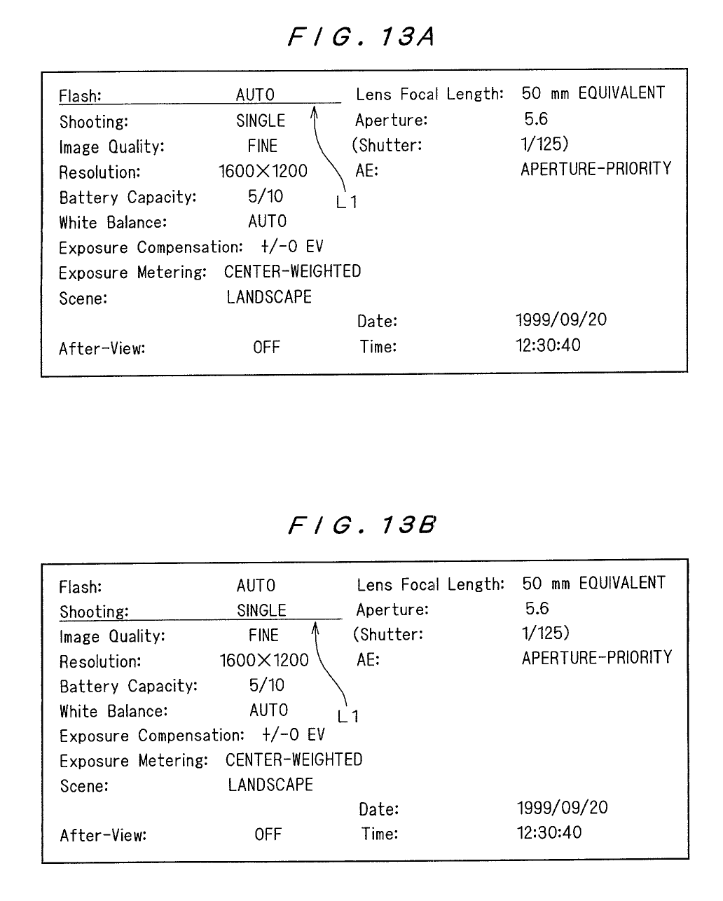

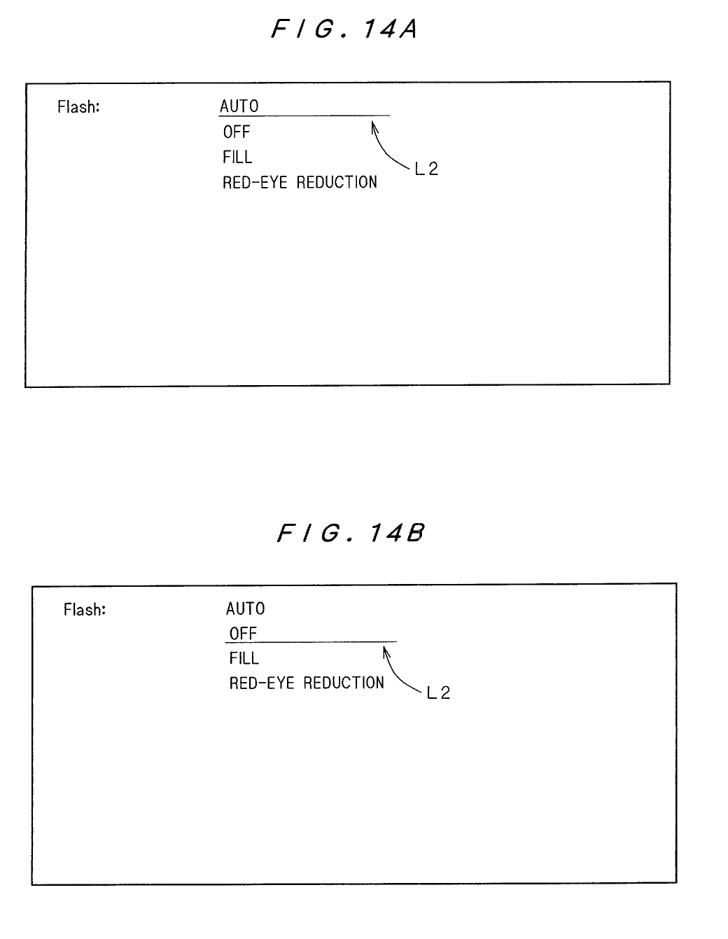

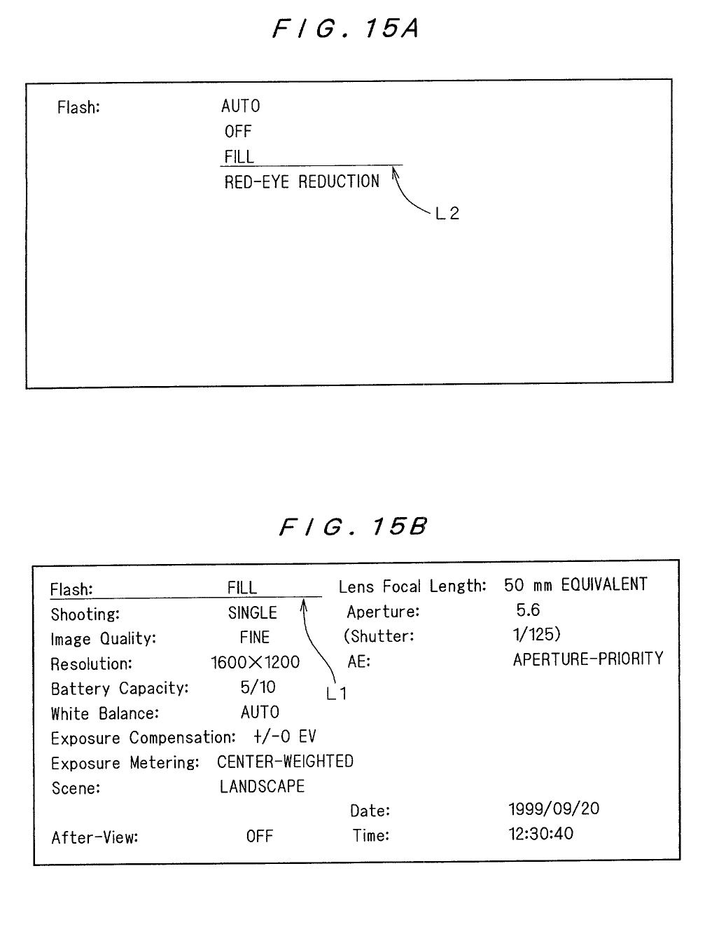

Next, the user can change settings from those appearing on the screen shown in FIG. 13A. Pressing the button R causes a setting selection screen for the item “flash” to appear, as shown in FIG. 14A. Then, pressing the button D moves an underline L2 downwardly one line to change the setting to “off,” as shown in FIG. 14B. Pressing the button D again moves the underline L2 downwardly one line to change the setting to “fill,” as shown in FIG. 15A. The user may press the button U to move the underline L2 upwardly one line. In this manner, the user can press the buttons U and D to select a desired setting.

For example, when the user selects the setting “fill” as shown in FIG. 15A and then presses the OK button 32, the current screen is changed to a camera status item selection screen (FIG. 15B) corresponding to the screen shown in FIG. 13A, and the desired settings are determined.

Table 2 shows the details of the items in the recording mode in association with the camera status and choices of settings selectable for each of the items. Information shown in Table 2 is stored in the ROM of the overall controller 211.

TABLE 2

| Item | Choices | | | |
|---|---|---|---|---|
| Flash | Auto | Off | Fill | Red-Eye |
| | | | | Reduction |
| Shooting | Single | Continuous | | |
| Image | Fine | Uncompressed | Standard | |
| Quality | | | | |
| Resolution | 1600 × 1200 | 1024 × 768 | 800 × 600 | 640 × 480 |
| White | Auto | Daylight | Tungsten | Fluorescent |
| Balance | | | | |
| Exposure | +/−2 EV | | | |
| Compen- | Adjustable by R and L keys (in predetermined step-by-step | | | |
| sation | increments and decrements) | | | |
| Exposure | Center- | Averaging | | |
| Metering | Weighted | | | |
| Scene | Landscape | Portrait | Nighttime | |
| After-View | Off | On | Additional | |
| | | | Information | |
| Lens Focal | 35-105 mm | | | |
| Length | Adjustable by R and L keys (in predetermined step-by-step | | | |
| | increments and decrements) | | | |
| Aperture | 4-16 | | | |
| | Adjustable by R and L keys (in predetermined step-by-step | | | |
| | increments and decrements) | | | |
| | Unselectable when AE is programmed or shutter-priority | | | |
| | (Display only) | | | |
| Shutter | 8-1/4000 | | | |
| | Adjustable by R and L keys (in predetermined step-by-step | | | |
| | increments and decrements) | | | |
| | Unselectable when AE is programmed or aperture-priority | | | |
| | (Display only) | | | |
| AE | Programmed | Aperture- | Shutter- | Manual |
| | | Priority | Priority | |

| Format | To format menu | |
|---|---|---|
| Date | 1999/09/20 | Adjustable by R, L, U and D keys |
| Time | 12:30:40 | |

In Table 2, for example, the item “flash” has four selectable settings: “auto,” “off,” “fill,” and “red-eye reduction.”

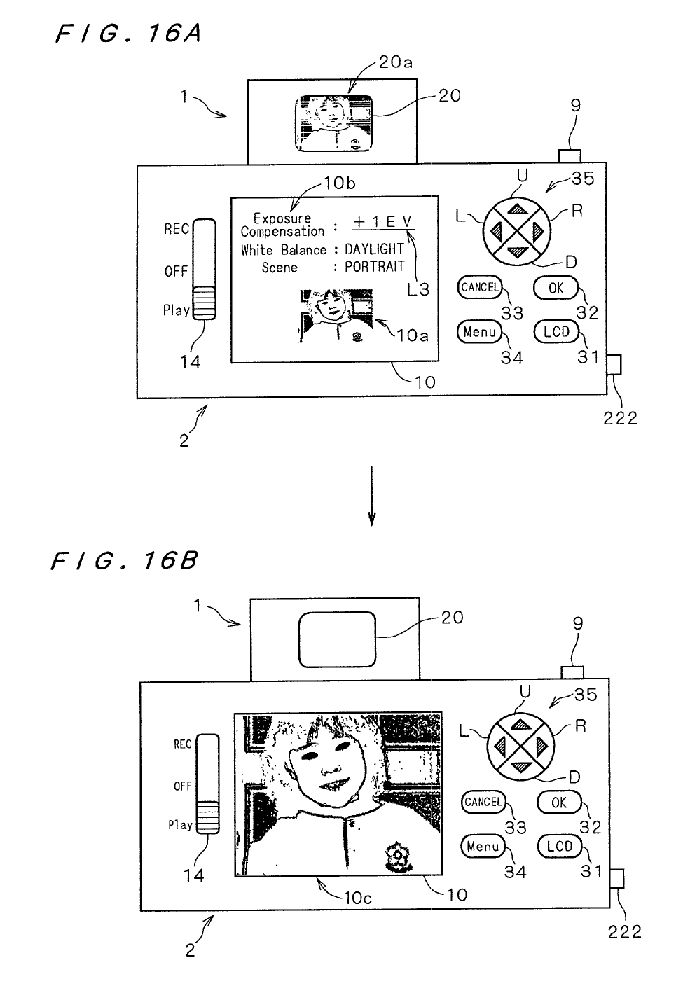

The user may input the settings of the items “white balance,” “exposure compensation,” and “scene” while contrasting the captured image and a corrected image with each other as shown in FIG. 16A when inputting at setting of image correction of the image data captured by the CCD 303 (to be described later).

The above-mentioned operation of inputting the camera status setting allows the user to easily associate the captured image displayed on the EVF 20 with the recording mode settings displayed on the LCD 10. This is effective, for example, in the case where the user checks how the captured image is associated with the white balance setting when the captured image on display appears bluish.

Reference will be made again to the flowchart of FIG. 10 for the following description.

In Step ST23, whether or not the LCD button 31 is pressed is judged. If the LCD button 31 is pressed, the flow proceeds to Step ST24. If the LCD button 31 is not pressed, the flow proceeds to Step ST25.

In Step ST24, zero is substituted for the display mode (LCD&EVF_Status). This process step causes the LCD 10 to produce the live view display of the captured image, to avoid the situation in which the captured image is not at all displayed, thereby enhancing the operability of the digital camera 1.

In Step ST25, whether or not the OK button 32 is pressed to complete the input operation is judged. If the input operation is completed, the flow proceeds to Step ST29. If the input operation is not completed, the flow returns to Step ST21.

In Step ST26, a judgement is made as to whether or not the EVF 20 is off (in a non-display state), i.e., whether or not the display mode (LCD&EVF_status) is “0.” If the EVF 20 is off, the flow proceed to Step ST27. If the EVF 20 is on (in a display state), the flow proceeds to Step ST28.

In Step ST27, a captured image is displayed on the EVF 20 which has been in the non-display state in Step ST26. This displays the images on both the LCD 10 and the EVF 20 to prevent the situation in which images to be compared are not displayed in an image correction operation in Step ST28.

The user inputs a setting of image correction of the image data captured by the CCD 303 in Step ST28. The captured image and the like are displayed on the LCD 10 and the EVF 20, based on the display mode (LCD&EVF_Status) in Step ST29. A series of operations associated with the input of the setting of the image correction will be described hereinafter.

FIGS. 16A and 16B are views corresponding to the rear view of the digital camera 1 shown in FIG. 3 and illustrate the operation of inputting the setting of image correction.

The operation of inputting the setting of image correction to be described below starts with the display mode “0” (in a state similar to that illustrated in FIG. 16B) in which the EVF 20 is off and the LCD 10 produces the live view display.

When the menu button 34 is pressed (Step ST17 of FIG. 9) in the display mode “0,” the EVF 20 which has been off is forced to turn on to produce a setting input display as shown in FIG. 16A (Steps ST26 to ST28 of FIG. 10).

In the digital camera 1, an original captured image 20a in which settings before image correction are reflected is displayed on the EVF 20, and a corrected image 10a equal in display size to the captured image 20a is displayed on the LCD 10. A setting display 10b about correctable items associated with image correction, more specifically “exposure compensation,” “white balance” and “scene,” also appears on the LCD 10. The user presses the buttons U, D, L and R to move an underline L3, thereby inputting the settings, as in the operation of inputting the camera status setting. The setting of “exposure compensation” is adjustable in ⅓ step increments and decrements within the range from −2 EV to +2 EV.

When a setting of a correctable item is changed, the corrected image 10a in which the changed setting is reflected appears on the LCD 10, although the captured image 20a before the correction remains displayed on the EVF 20. This allows the user to contrast the captured image 20a and the corrected image 10a with each other, to easily judge whether or not the settings are proper. If the image 10a having a desired display characteristic is displayed on the LCD 10, the user presses the OK button 32 to complete the input operation (Step ST25).

Upon completion of the setting input operation, the digital camera 1 returns to the display mode “0” which has been set immediately before the image correction setting operation. In other words, the EVF 20 turns off, and the live view display of the captured image having suitable settings of image correction is produced on the LCD 10.

The above-mentioned image correction setting input operation allows the user to contrast the captured image displayed on the EVF 20 and the corrected image displayed on the LCD 10 with each other, to enhance convenience.

In the above described operations of the digital camera, the EVF 20 displays the captured image, and the LCD 10 produces the camera status display 10s, the image correction setting display 10b or the additional information display 10g. This achieves the effective use of the two monitors, i.e., the LCD 10 and the EVF 20.

<Modifications>

In the above-mentioned preferred embodiment, the captured image is displayed on the EVF 20, and information different from the captured image is displayed on the LCD 10. Instead, the captured image may be displayed on the LCD 10 and the information different from the captured image may be displayed on the EVF 20.

The present invention is not limited to the digital cameras which mainly capture still images according to the preferred embodiment, but is applicable to video cameras capable of capturing moving images. In other words, the “image capturing apparatus,” as that term is used herein, may capture either still images or moving images.

While the invention has been described in detail, the foregoing description is in all aspects illustrative and not restrictive. It is understood that numerous other modifications and variations can be devised without departing from the scope of the invention.

What is claimed is:

1. An image capturing apparatus comprising:
a first display capable of electrically displaying a captured image;
a second display capable of electrically displaying a captured image; and
a controller for simultaneously causing said first display to display said captured image and said second display to display information different from said captured image.

2. The image capturing apparatus according to claim 1,
wherein said second display simultaneously displays said information and said captured image.

3. The image capturing apparatus according to claim 1, further comprising
a selector for selectively turning on/off display on said first and second displays.

4. The image capturing apparatus according to claim 3,
wherein at least one of said first and second displays displays an image preceding an image to be actually shot.

5. The image capturing apparatus according to claim 1,
wherein said information includes information about a setting in a shooting mode.

6. The image capturing apparatus according to claim 1,
wherein said information includes information about said captured image having been subjected to image correction.

7. The image capturing apparatus according to claim 6,
wherein said information includes a correctable item associated with said image correction, and information about a setting of said correctable item.

8. The image capturing apparatus according to claim 6,
wherein said controller forces said first display to turn on when performing said image correction.

9. The image capturing apparatus according to claim 1,
wherein said information includes additional information about said captured image.

10. The image capturing apparatus according to claim 9,
wherein said additional information includes a histogram regarding exposure of said captured image.

11. The image capturing apparatus according to claim 10,
wherein said histogram is displayed immediately after shooting.

12. The image capturing apparatus according to claim 9,
wherein said additional information includes information recorded at the time of shooting.

13. A method of display control in an image capturing apparatus including a first display and a second display both capable of electrically displaying a captured image, said method comprising:
displaying a captured image on said first display; and
displaying information different from said captured image on said second display at the same time that said captured image is displayed on said first display.
